(19) United States
(12) Patent Application Publication
(10) Pub. No.: US 2024/0430942 A1
(43) Pub. Date: Dec. 26, 2024

(54) METHOD, DEVICE AND COMPUTER READABLE MEDIUM FOR COMMUNICATIONS

(71) Applicant: NEC CORPORATION, Tokyo (JP)

(72) Inventors: Gang WANG, Beijing (CN); Zhaobang MIAO, Beijing (CN); Lin LIANG, Beijing (CN)

(73) Assignee: NEC CORPORATION, Tokyo (JP)

(21) Appl. No.: 18/692,896

(22) PCT Filed: Sep. 29, 2021
(86) PCT No.: PCT/CN2021/121675

§ 371 Date: Mar. 18, 2024

(51) Int. Cl. H04W 74/0833; H04W 74/00

(52) U.S. Cl. CPC H04W 74/0833; H04W 74/002

(57) ABSTRACT

Embodiments of the present disclosure relate to methods, devices and computer readable media for communications. A method comprises determining, at a first terminal device, a reference duration. A method also comprises determining, based on the reference duration, a value of a contention window for a channel access procedure for sidelink.

### TECHNICAL FIELD

Embodiments of the present disclosure generally relate to the field of telecommunication, and in particular, to methods, devices and computer readable media for sidelink communication.

### BACKGROUND

Sidelink in unlicensed spectrum or band (SL-U) is a key topic in Release 18 of the 3rd Generation Partnership Project (3GPP). SL-U should base on New Radio (NR) sidelink and NR-U.

For a sidelink terminal device worked in unlicensed band, a Clear Channel Assessment (CCA) procedure should be used to access a channel. Before the sidelink terminal device performs the CCA procedure, a contention window (CW) should be determined. One or more factors used for determining the CW should be evaluated or measured within a reference duration.

### SUMMARY

In general, example embodiments of the present disclosure provide methods, devices and computer readable media for communications.

In a first aspect, there is provided a method for communications. The method comprises determining, at a first terminal device, a reference duration; and determining, based on the reference duration, a value of a contention window for a channel access procedure for sidelink.

In a second aspect, there is provided a method for communications. The method comprises determining, at a control node device, a reference duration, wherein the reference duration is related to determination of a contention window for a channel access procedure for sidelink; and transmitting information about the reference duration.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a control node device. The control node device comprises a processor and a memory storing instructions. The memory and the instructions are configured, with the processor, to cause the control node device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of a sub-channel in accordance with some embodiments of the present disclosure;

FIG. 3 illustrates an example of Physical Sidelink Shared Channel (PSSCH) and Physical Sidelink Feedback Channel (PSFCH) resources in accordance with some embodiments of the present disclosure;

FIG. 4 illustrates a flowchart of an example method in accordance with some embodiments of the present disclosure;

FIGS. 5A to 7I illustrate an example of a reference duration in accordance with some embodiments of the present disclosure, respectively;

FIG. 8A illustrates a flowchart of an example method 800 for determining CW in accordance with some embodiments of the present disclosure;

FIGS. 8B to 8G illustrate an example of a reference duration in accordance with some other embodiments of the present disclosure, respectively;

FIG. 9 illustrates a flowchart of an example method in accordance with some other embodiments of the present disclosure;

FIG. 10 illustrates an example of a reference duration in accordance with still other embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices. Ultra-reliable and Low Latency Communications (URLLC) devices. Internet of Everything (IoE) devices, machine type communication (MTC) devices, device on vehicle for V2X communication where X means pedestrian, vehicle, or infrastructure/network, devices for Integrated Access and Backhaul (IAB). Space borne vehicles or Air borne vehicles in Non-terrestrial networks (NTN) including Satellites and High Altitude Platforms (HAPs) encompassing Unmanned Aircraft Systems (UAS). eXtended Reality (XR) devices including different types of realities such as Augmented Reality (AR). Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical. V2X applications, transparent IPv4/IPv6 multicast delivery. IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges. e.g. FR1 (410 MHZ-7125 MHZ). FR2 (24.25 GHz to 71 GHZ), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, for a sidelink terminal device worked in unlicensed band, a CCA procedure (or named as channel access procedure) should be used to access a channel. Before the sidelink terminal device performs the CCA procedure, a CW should be determined. One or more factors used for determining the CW should be evaluated or measured within a reference duration.

Embodiments of the present disclosure provide a solution for sidelink transmission so as to solve the above problems and one or more of other potential problems. According to the solution, a first terminal device determines a reference duration. In turn, the first terminal device determines, based on the reference duration, a value of a contention window for a channel access procedure for sidelink. In this way, one or more factors used for determining the CW should be evaluated or measured within the determined reference duration.

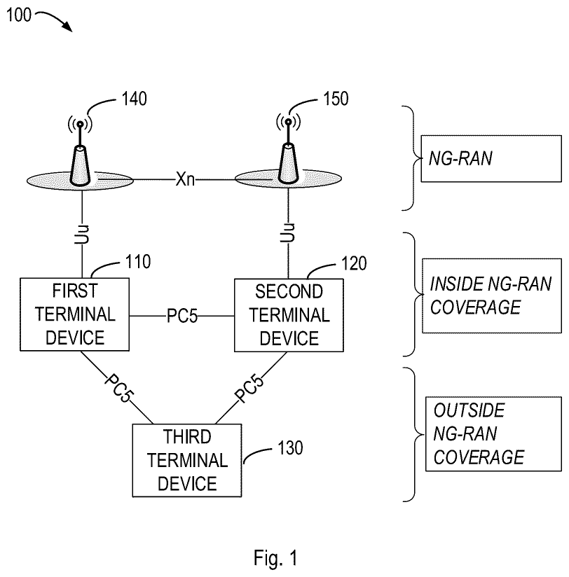

FIG. 1 illustrates a schematic diagram of an example communication network 100 in which embodiments of the present disclosure can be implemented. As shown in FIG. 1, the communication network 100 may include a first terminal device 110, a second terminal device 120, a third terminal device 130, network devices 140 and 150. The network devices 140 and 150 may communicate with the first terminal device 110, the second terminal device 120 and the third terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

The communications in the communication network 100 may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the communications in the communication network 100 may comprise sidelink communication. Sidelink communication is a wireless radio communication directly between two or more terminal devices, such as two or more terminal devices among the first terminal device 110, the second terminal device 120 and the third terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the first terminal device 110) to a target terminal device (such as the second terminal device 120) through the Unified Air Interface, e.g., PC5 interface, as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

The first terminal device 110, the second terminal device 120 and the third terminal device 130 may use sidelink channels to transmit sidelink signaling or information. The sidelink channels include at least one of the following: a Physical Sidelink Control Channel (PSCCH) resource which is used for carrying sidelink control information (SCI), a Physical Sidelink Shared Channel (PSSCH) resource which is used for carrying sidelink data service information, a physical sidelink feedback channel (PSFCH) resource which is used for carrying sidelink ACK/NACK (A/N) feedback information, a physical sidelink broadcast channel (PSBCH) resource which is used for carrying sidelink broadcast information, and a physical sidelink discovery channel (PSDCH) resource which is used for carrying a sidelink discovery signal.

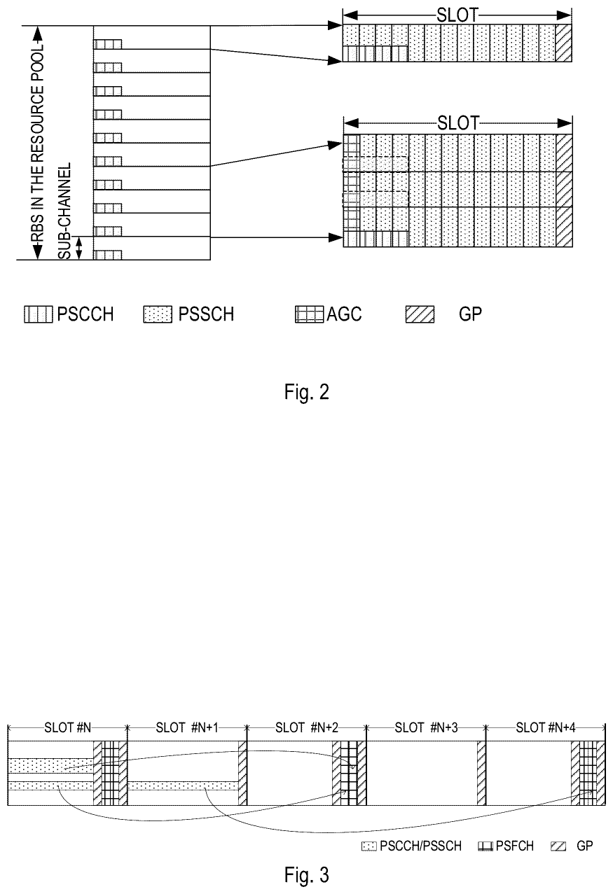

Within a resource pool, a PSSCH resource includes all the symbols in a slot that are configured as sidelink available symbols, and one or more sub-channels in frequency domain, where each sub-channel contains an integer number of consecutive RBs. The number m of RBs included in one sub-channel is also called the sub-channel size. Each slot contained in the resource pool contains multiple available sidelink symbols, and the PSSCH resource is located in the time domain from the first available sidelink symbol in this slot to all available symbols. In the frequency domain, the resource pool contains multiple RBs, according to the sub-channel size m, starting from the first RB in the resource pool, each m RBs are divided into one sub-channel, and each PSSCH channel resource is located on one or more sub-channels. When one of the first terminal device 110, the second terminal device 120 and the third terminal device 130 uses the PSSCH resource to send sidelink information, it can use one or more sub-channels to carry corresponding data information. A PSCCH resource includes t symbols in time domain, and k RBs in frequency domain. Each PSCCH channel resource is located at consecutive/symbols starting from the first symbol in the available symbols in the time domain, and located at the position of consecutive k RBs starting from the first RB in the corresponding sub-channel in the frequency domain, as shown in FIG. 2.

Within a resource pool, whether a PSFCH resource is available should be configured or pre-configured. According to the configuration or pre-configuration of a resource pool, one of every N slots in the resource pool contains PSFCH resources, N=[1,2,4]. In a sidelink resource pool, PSCCH/PSSCH resources are presented in every slot and used for transmitting sidelink data packet. While PSFCH is used for carrying sidelink ACK/NACK (A/N) of corresponding sidelink data packet on the assigned slots. Based on that, the time interval between A/N on PSFCH and the corresponding sidelink data packet on PSSCH are various.

FIG. 3 illustrates an example of PSSCH and PSFCH resources in accordance with some embodiments of the present disclosure. In the example, N=2, i.e., one out of every two slots in the resource pool contain PSFCH resource. Accordingly, the A/N related to the PSSCH in slot #n should be reported on PSFCH in slot #n+2, i.e., the time interval between data and A/N is two slots. For the data transmission on PSSCH in slot #n+1, the corresponding A/N should be reported in slot #n+4, i.e., the time interval between data and A/N is three slots.

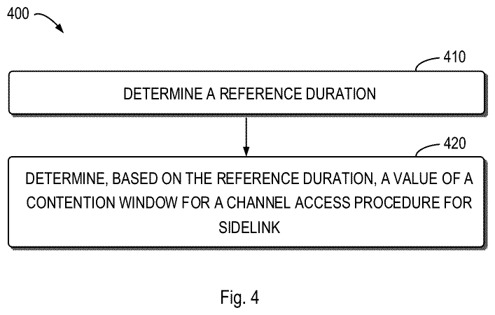

FIG. 4 illustrates a flowchart of an example method 400 in accordance with some embodiments of the present disclosure. In some embodiments, the method 400 can be implemented at a terminal device, such as one of the first terminal device 110, the second terminal device 120 and the third terminal device 130 as shown in FIG. 1. For the purpose of discussion, the method 400 will be described with reference to FIG. 1 as performed by the first terminal device 110 without loss of generality.

At block 410, the first terminal device 110 determines a reference duration. At block 420, the first terminal device 110 determines, based on the reference duration, a value of a CW for a channel access procedure for sidelink.

In some embodiments, the first terminal device 110 may determine the reference duration by determining at least one of the following: a beginning of the reference duration, an end of the reference duration, or a length of the reference duration.

In some embodiments, the first terminal device 110 may determine the beginning or the end of the reference duration based on at least one of the following:
a timing, for example, t₀ s, t₀ ms or t₀ us;
a boundary of a slot or a first type of slot,
a boundary of a sidelink Channel Occupancy (CO),
a boundary of a burst within the sidelink CO,
a boundary of a first type of sidelink channel,
a timing related to the determine of the value of the contention window,
a timing related to the channel access procedure for sidelink, or
a timing related to a sidelink grant.

In some embodiments, the boundary of the slot may be a beginning or an end of the slot, the boundary of the first type of slot may be a beginning or an end of the first type of slot, the boundary of the sidelink CO may be a beginning or an end of the sidelink CO, the boundary of the burst within the sidelink CO may be a beginning or an end of the burst, or the boundary of the first type of sidelink channel may be a beginning or an end of the first type of sidelink channel.

In embodiments where the beginning or the end of the reference duration is determined based on the timing related to the determining of the value of the CW, the beginning or the end of the reference duration may be determined as a timing when starting the determining of the value of the CW. Alternatively, the beginning or the end of the reference duration may be determined as before a timing when starting the determining of the value of the CW.

In embodiments where the beginning or the end of the reference duration is determined based on the timing related to the channel access procedure for sidelink, the beginning or the end of the reference duration may be determined as a timing when starting the channel access procedure for sidelink. Alternatively, the beginning or the end of the reference duration may be determined as before a timing when starting the channel access procedure for sidelink.

In embodiments where the beginning or the end of the reference duration is determined based on the timing related to the sidelink grant, the beginning or the end of the reference duration may be determined as a timing when receiving the sidelink grant. Alternatively, the beginning or the end of the reference duration may be determined as before a timing when receiving the sidelink grant.

In some embodiments, the first terminal device 110 may determine the length of the reference duration based on at least one of the following:
a timing interval, for example, t s, t ms or t us;
a duration which contains a first number of slots or frames,
a duration which contains a second number of sets of a first type of sidelink channel,
a duration which contains a third number of sidelink COs,
a duration which contains a fourth number of bursts within a sidelink CO, or
a duration which contains a fifth number of a first type of slot.

In some embodiments, the sidelink CO may be at least one of the following: a CO initiated by a sidelink terminal device, or a CO which contains a sidelink transmission, a CO which contains a sidelink channel. In some embodiments, the sidelink transmission may comprise at least one of sidelink transmission and Uu transmission within the CO.

In some embodiments, the sidelink CO may be a CO initiated by a control node device for sidelink especially. In some embodiments, the control node device may be network device, a road side unit (RSU), or a header terminal device in a group of sidelink communication.

In some embodiments, the first type of sidelink channel may comprise at least one of the following: PSSCH, PSCCH, PSFCH, PSBCH, or PSDCH.

In some embodiments, the first type of slot may comprise at least one of the following: a slot which is contained in a sidelink CO, a slot which is contained in a sidelink resource pool, a slot which contains a sidelink transmission, or a slot which contains a sidelink channel.

In some embodiments, the first terminal device 110 may determine the length of the reference duration based on the duration which contains the second number of sets of the first type of sidelink channel. Each of the sets of the first type of sidelink channel comprises the first type of sidelink channels contained in one slot.

In some embodiments, the first number, the second number, the third number, the fourth number, or the fifth number may be determined according to at least one of the following: a pre-definition, a pre-configuration, a configuration from a network device, or a configuration from a sidelink terminal device.

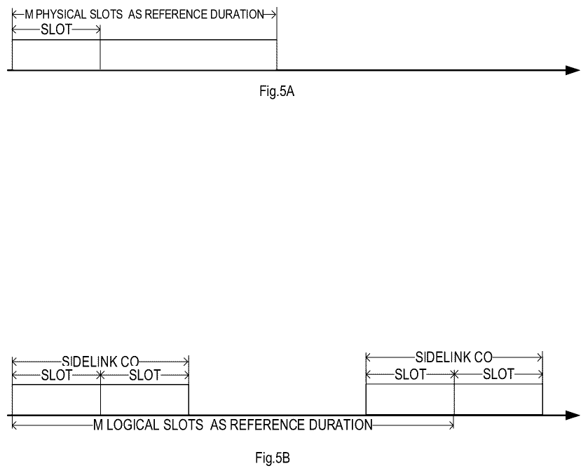

Hereinafter, examples of the reference duration will be described with reference to FIGS. 5A to 7I and FIGS. 8B to 8G.

In each of examples as shown in FIGS. 5A and 5B, a length of a reference duration is pre-configured as M=3 slots. In the example as shown in FIG. 5A, the M slots are physical consecutive slots. In the example as shown in FIG. 5B, the M slots are the first type of slot which is contained in sidelink CO. Therefore, M logical consecutive slots in more than one sidelink COs are used as a reference duration.

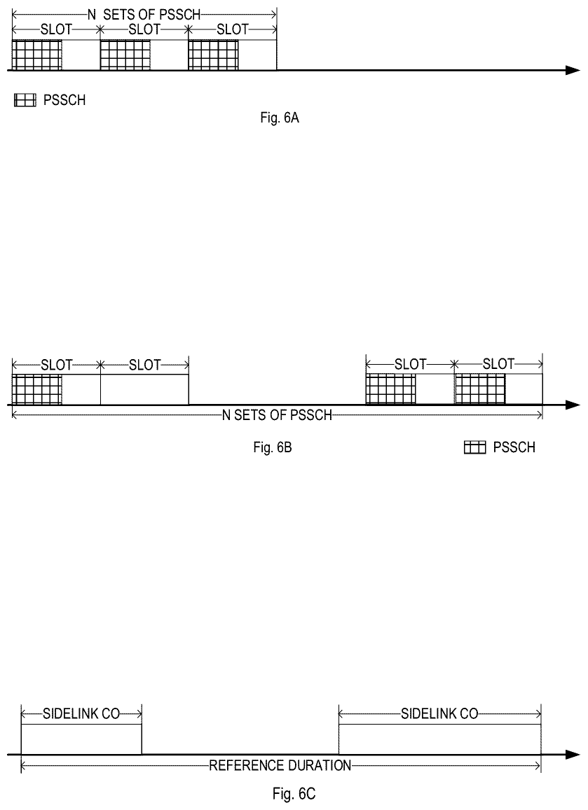

In an example as shown in FIG. 6A, a length of a reference duration is determined as a duration of N=3 sets of PSSCH resources, wherein a set of PSSCH resources comprises one or more PSSCH resources within the same slot. Therefore, the length of the reference duration is determined according to the sidelink resource scheme, i.e., the time window contains N slots each of which may contain a set of PSSCH resource.

An example as shown in FIG. 6B differs from the example as shown in FIG. 6A in that N=3 sets of PSSCH resources are located in logical consecutive N slots.

In an example as shown in FIG. 6C, a length of a reference duration is determined as a duration of k₁=2 sidelink COs.

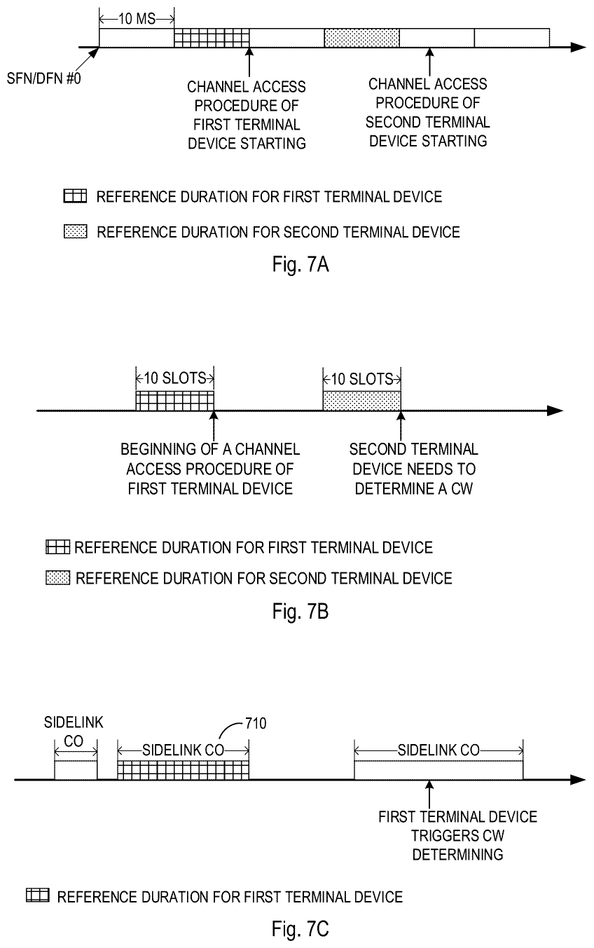

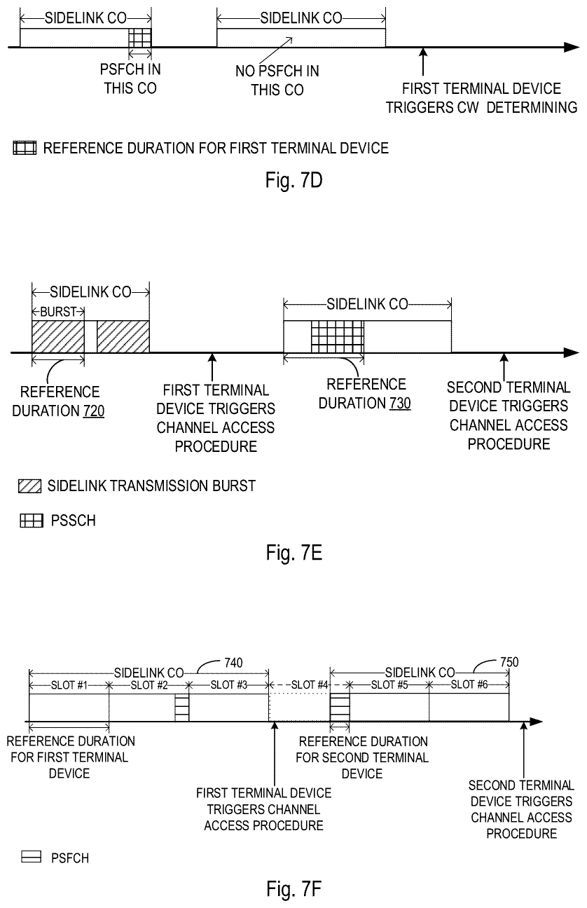

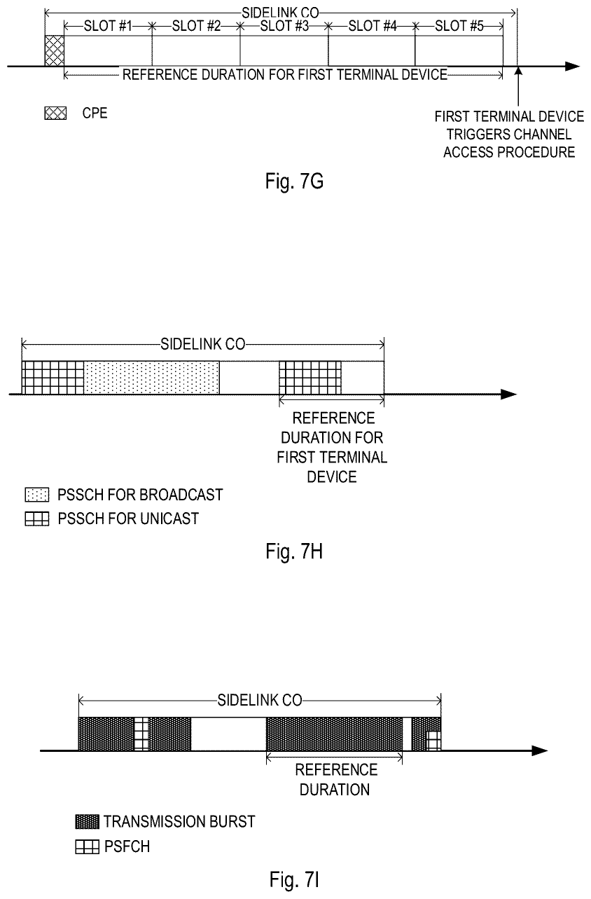

In some embodiments, the first terminal device 110 may determine the length of the reference duration as a timing interval which has a fixed value according to pre-definition. The fixed value may be M ms. In such embodiments, the first terminal device 110 may determine the end of the reference duration as a timing before starting the channel access procedure for sidelink. The timing is a multiple of the length of the reference duration from a beginning of a system frame (SFN) or a beginning of a direct frame (DFN). In this way, the reference duration may be easily determined according to SFN or DFN and the fixed length. By using such a common definition of the reference duration, it may be used for any terminal devices and factors for CW determining without introducing additional overhead or complexity. This will be described with reference to FIG. 7A.

FIG. 7A illustrates an example of reference durations in accordance with some embodiments of the present disclosure. As shown, M=10, i.e., a length of a reference duration equals to 10 ms. A plurality of reference durations are periodically continuous presented and start from a beginning of SFN #0 or DFN #0. For the first terminal device 110 or the second terminal device 120, according to starting of a channel access procedure for sidelink, a relevant reference duration may be determined respectively. The last integrated reference duration before a terminal device starts its channel access procedure for sidelink procedure may be used as the relevant reference duration, and further used for CW determining.

In some embodiments, the first terminal device 110 may determine the length of the reference duration as a duration which contains a sixth number of slots. The first terminal device 110 may determine the end of the reference duration as one of the following: a timing when starting the channel access procedure, a timing when receiving a sidelink grant, or a timing when starting the determining of the value of the CW. In such embodiments, the reference duration is determined based on the relevant timing of CW determining or beginning of channel access procedure, and it may provide the latest information or situation in the reference duration which may benefit the procedure. This will be described with reference to FIG. 7B.

FIG. 7B illustrates an example of reference durations in accordance with some embodiments of the present disclosure. As shown, a reference duration for the first terminal device 110 is determined based on a beginning of a channel access procedure of the first terminal device 110, a reference duration for the second terminal device 120 is determined based on the relevant timing of CW determining of the second terminal device 120. The length of the reference duration is 10 slots, i.e., the sixth number equals to 10, which is pre-configured in system.

In some embodiments, the first terminal device 110 may determine the length of the reference duration as a duration which contains one sidelink CO. In such embodiments, the first terminal device 110 may determine the end of the reference duration as an end of the sidelink CO. The end of the sidelink CO is before a timing when starting the determining of the value of the CW. In this way, the reference duration is determined based on the sidelink CO, which may provide more effective information or situation of sidelink transmission and may be combined with the scheme that CW should be determined based on relevant sidelink channel or information. This will be described with reference to FIG. 7C.

In an example as shown in FIG. 7C, the first terminal device 110 determines a length of a reference duration as a duration which contains a sidelink CO 710. An end of the sidelink CO 710 is before a timing when the first terminal device 110 starts the determining of the value of the CW.

In some embodiments, the first terminal device 110 may determine the length of the reference duration as a duration which contains a second number of a first type of sidelink channel in a sidelink CO. In such embodiments, the first terminal device 110 may determine the end of the reference duration as an end of the first type of sidelink channel. The end of the first type of sidelink channel is before a timing when starting the determining of the value of the CW.

In an example as shown in FIG. 7D, the first terminal device 110 determines a reference duration as a duration of a last PSFCH, i.e., PSFCH is defined as the first type of sidelink channel, which is contained in a sidelink CO for the first terminal device 110.

In some embodiments, the first terminal device 110 may determine the beginning of the reference duration as a beginning of a sidelink CO, the end of the sidelink CO being before a timing when starting the determining of the value of the CW. In such embodiments, the first terminal device 110 may determine an end of the reference duration as one of the following, whichever occurs earlier: an end of a starting slot within the sidelink CO, an end of a starting burst within the sidelink CO, or an end of the first type of sidelink channel within the sidelink CO. It provides more flexibility on reference duration determining as the end of a reference duration may be an earlier one which satisfies the pre-defined rules. In such embodiments, a shorter reference duration may be obtained which may benefit the CW determining and channel access procedure. This will be described with reference to FIGS. 7E and 7F.

In an example as shown in FIG. 7E, a beginning of a reference duration 720 for the first terminal device 110 is determined as a beginning of a last sidelink CO for the first terminal device 110, and an end of the reference duration 720 is determined as an end of a starting burst (i.e., the first burst in order) in the last sidelink CO. A beginning of a reference duration 730 for the second terminal device 120 is determined as a beginning of a last sidelink CO for the second terminal device 120, and an end of the reference duration 730 is determined as an end of a starting PSSCH (i.e., the first PSSCH in order) in the last sidelink CO for the second terminal device 120.

In some embodiments, for the case that more than one potential ends of a reference duration are presented in a same sidelink CO, the earlier one may be used as the end of the relevant reference duration. As shown in FIG. 7F, PSFCH is the first type of sidelink channel. For the first terminal device 110, in a last sidelink CO 740, PSFCH is presented in the second slot in the CO 740. A beginning of a reference duration for the first terminal device 110 is determined as a beginning of the CO 740, and an end of the reference duration for the first terminal device 110 is determined as an end of a starting slot (i.e., the first slot in order) in the CO 740. In other words, the end of the reference duration for the first terminal device 110 is determined as an end of a slot #1 in the CO 740.

On the other hand, for the second terminal device 120, in a last sidelink CO 750, PSFCH is presented at a beginning of the CO 750, and the first integrated slot is the slot #5 in the CO 750. A beginning of a reference duration for the second terminal device 120 may be determined as a beginning of the CO 750, and an end of the reference duration for the second terminal device 120 may be determined as an end of the PSFCH.

In some embodiments, the first terminal device 110 may determine the beginning of the reference duration as a beginning of a starting slot within a sidelink CO. The end of the sidelink CO is before a timing when starting the channel access procedure for sidelink. In such embodiments, the first terminal device 110 may determine the length of the reference duration as a number of slots. In such embodiments, the beginning of the reference duration is from a practical beginning of sidelink transmission which may be not aligned with a beginning of a sidelink CO. Based on that, the relevant CW may be determined more precisely. This will be described with reference to FIG. 7G.

In an example as shown in FIG. 7G, within a last sidelink CO received by the first terminal device 110, a cyclic prefix extension (CPE) signal is transmitted at a beginning of the CO, and an actual sidelink information is transmitted from slot #1. According to the rule of reference duration determining, the first terminal device 110 determines a beginning of a reference duration as a beginning of a starting slot (i.e. slot #1) in the CO, and an end of the reference duration as an end of slot #5.

In some embodiments, the first terminal device 110 may determine the beginning of the reference duration as a beginning of a last PSSCH within a sidelink CO, the last PSSCH containing sidelink data for unicast. The first terminal device 110 may determine the end of the reference duration as an end of the sidelink CO. Such embodiments may be used for the CW determining which is based on factors related to a specified sidelink channel, and provide available and efficient reference duration. This will be described with reference to FIG. 7H.

In an example as shown in FIG. 7H, according to CW determining rules, a reference duration is determined based on some specific sidelink information or transmission on specific sidelink channel, i.e., the first type of sidelink channel. For this case, PSSCH used for unicast is pre-configured as the first type of sidelink channel, and the reference duration of a sidelink CO is determined according to the last PSSCH in the CO.

The first terminal device 110 receives sidelink signals in a CO which contain several sidelink data packets. For each packet, there is a SCI on PSCCH which indicate the relevant sidelink data packet on PSSCH is for unicast, groupcast, or broadcast. Then, the first terminal device 110 may determine the reference duration of this CO. A beginning of the reference duration is determined as a beginning of the last PSSCH used for unicast and an end of the reference duration is determined as an end of the CO, as shown in FIG. 7H.

In some embodiments, to use a last sidelink burst with certain length, it requires no short sidelink channel contained in the last sidelink burst. In such embodiments, the first terminal device 110 may determine the beginning of the reference duration as a beginning of a last burst within a sidelink CO, the last burst containing no second type of sidelink channels. The first terminal device 110 may determine the end of the reference duration as an end of the last burst. In some embodiments, the second type of sidelink channels comprise at least one of the following: PSFCH, PSDCH, or PSBCH. Based on the reference duration according to the burst, further CW determining may be more precisely. This will be described with reference to FIG. 7I.

In an example as shown in FIG. 7I, more than one transmission bursts are contained within a sidelink CO. The last burst in the CO involves a PSFCH and then it may not be used as a reference duration. Accordingly, the burst before the last burst in the CO may be used as the reference duration of the current sidelink CO.

In some embodiments, the first terminal device 110 may determine one or more reference durations. Each of the reference durations may be related to at least one of the following factors: a sidelink Hybrid Automatic Repeat Request (HARQ) feedback, SCI, a Channel Busy Ratio (CBR) of sidelink, or a Channel Occupancy Ratio (CR) of sidelink. The first terminal device 110 may determine the value of the CW according to at least one of the above factors within one of the reference durations.

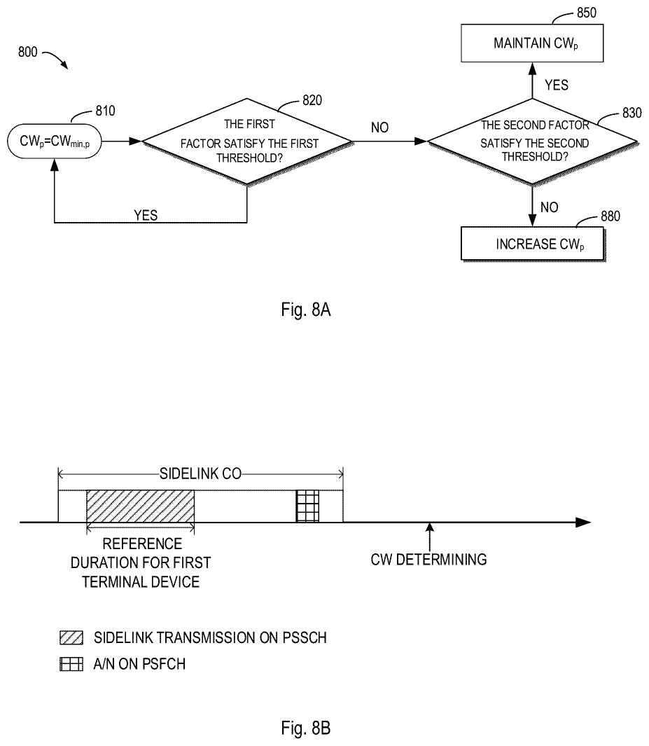

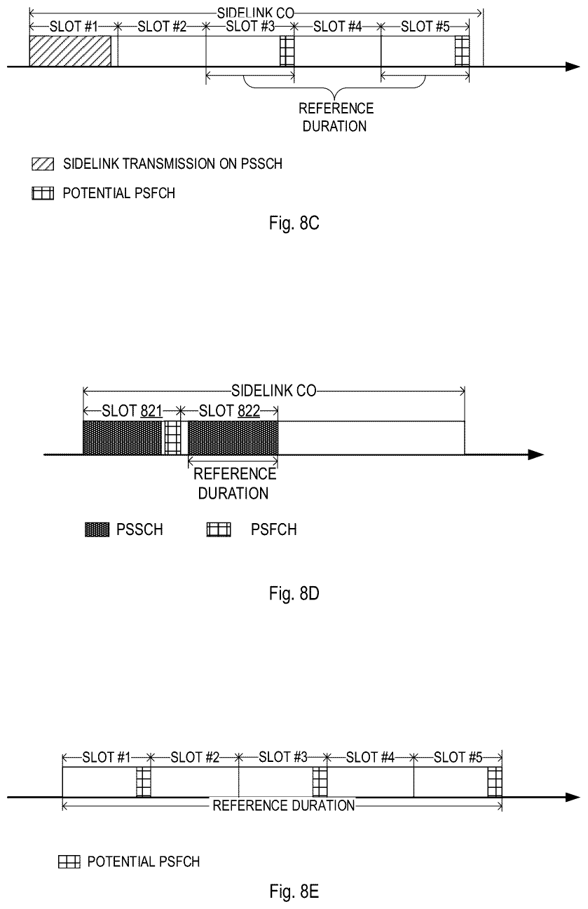

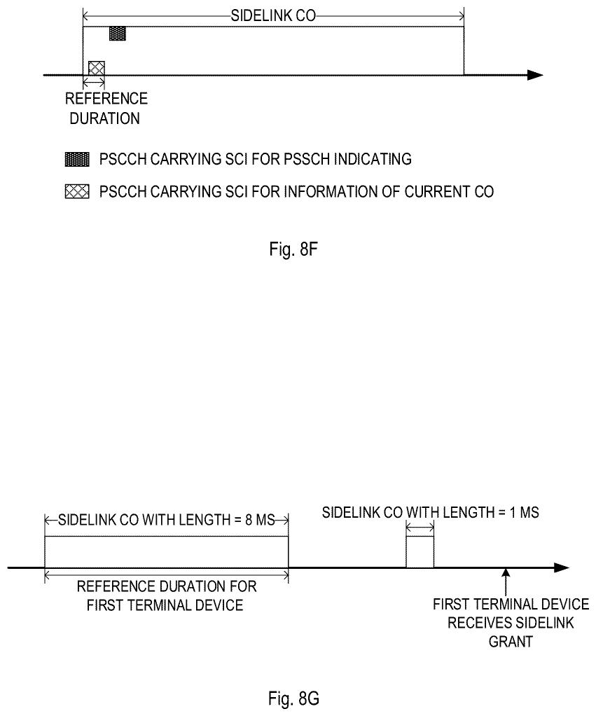

In some embodiments, there are two factors used in different steps of CW adjustment procedure, and two reference durations related to each factor may be determined and used respectively. For example, the first terminal device 110 may determine a first reference duration related to the sidelink HARQ feedback and a second reference duration related to the SCI. The first terminal device 110 may determine the value of the CW according to the sidelink HARQ feedback received in the first reference duration and the SCI received in the second reference duration. This will be described with reference to FIG. 8A.

FIG. 8A illustrates a flowchart of an example method 800 for determining CW in accordance with some embodiments of the present disclosure. In some embodiments, the method 800 can be implemented at a terminal device, such as the first terminal device 110 or the second terminal device 120 as shown in FIG. 1. For the purpose of discussion, the method 800 will be described with reference to FIG. 1 as performed by the first terminal device 110 without loss of generality.

In the example method 800, a value of a CW is determined based on two factors related to sidelink. The two factors may comprise a first factor related to sidelink and a second factor related to sidelink.

As shown in FIG. 8, at block 810, the first terminal device 110 sets CWₚ to be CW_{min,p}, i.e., CWₚ=CW_{min,p}.

At block 820, according to the determining rule of CWₚ, the first terminal device 110 determines whether a first factor satisfies the first threshold. The first factor is determined within a first reference duration. For example, the first factor may be a sidelink HARQ feedback. If the first factor satisfies the first threshold, the method 800 goes to block 810. Otherwise, the method 800 goes to block 830.

At block 830, according to the determining rule of CWₚ, the first terminal device 110 determines whether a second factor satisfies the second threshold. The second factor is different from the first factor. For example, the second factor may be SCI. The second factor is determined within a second reference duration. The second threshold may be the same as or different from the first threshold. The first and second thresholds may be configured, pre-configured or defined independently. If the second factor satisfies the second threshold, the method 800 goes to block 850. Otherwise, the method 800 goes to block 880.

At block 880, the first terminal device 110 increases CWₚ.

At block 850, the first terminal device 110 maintains CWₚ as it is for priority p.

The situation of sidelink communication is different from that of cellular communication and more optional configurations may be applied to it. Thus, determining of a reference duration based on a factor may provide more suitable CW and benefit channel access procedure for sidelink.

In some embodiments, the first terminal device 110 may determine a first reference duration among the reference durations. In turn, the first terminal device 110 may determine the value of the CW according to the first reference duration. For example, the first reference duration may comprise one of the following:
a reference duration which has the maximum or minimum length among the reference durations,
a reference duration which begins earliest among the reference durations,
a reference duration which ends earliest among the reference durations,
a reference duration which begins latest among the reference durations, or
a reference duration which ends latest among the reference durations.

In some embodiments, the first terminal device 110 may determine the reference duration as a duration of PSSCH associated with a sidelink HARQ feedback detected by the first terminal device 110. For the case that sidelink CW should be determined according to A/N feedback of a sidelink transmission, the duration of the transmission, i.e., the time window of the corresponding PSSCH resource, may be used as the relevant reference duration. Based on the reference duration, the A/N should be detected and used for CW determining and may provide accurate evaluation for channel status. This will be described with reference to FIG. 8B.

In the example as shown in FIG. 8B, for sidelink unicast communication in unlicensed band, the first terminal device 110 transmits sidelink data to the second terminal device 120 on PSSCH resource, and then the second terminal device 120 should report ACK or NACK to the first terminal device 110 depending on the receiving result of the data. Then, the first terminal device 110 may detect A/N corresponding to PSSCH in the reference duration. The reference duration is determined as a duration of PSSCH for which the relevant A/N should be used for CW determining. Further, the first terminal device 110 may determine CW for following channel access procedure.

In some embodiments, the first terminal device 110 may determine the reference duration as at least one of slots which contain PSFCH, wherein the PSFCH is detected by the first terminal device 110. For the case that CW is determined according to the situation of detected sidelink A/N on PSFCH, the reference duration may be determined as a time window which contains all the potential relevant PSFCH resources. Based on that, the reference duration should focus on the duration of relevant PSFCH resources and avoid introducing additional overhead for the terminal device. This will be described with reference to FIG. 8C.

In the example as shown in FIG. 8C, for sidelink groupcast communication in unlicensed band, the first terminal device 110 transmits sidelink data to more than one terminal devices in a group, and then receiving terminal devices may report ACK or NACK to the first terminal device 110 depending on the receiving result of the data. Then, the first terminal device 110 may detect A/N from different receiving terminal devices and further determine CW for following channel access procedure.

In the example as shown in FIG. 8C, as several receiving terminal devices may report A/N to the first terminal device 110 respectively, e.g., by using different PSFCH for each receiving terminal device, the first terminal device 110 may detect A/N on several PSFCH resource which may be involved in a same slot or different slots. Accordingly, the duration of the PSFCH resources which may be used for feedback A/N for the sidelink transmission of the first terminal device 110 should be used as the reference duration for the first terminal device 110.

As shown in FIG. 8C, according to the sidelink resource configuration, the PSFCH resources which may carry A/N for the relevant PSSCH are within slot #3 and slot #5. The reference duration is determined as a duration of slot #3 and slot #5 which includes two fragments in time domain, i.e., the reference duration is not a physical consecutive duration.

In some embodiments, the first terminal device 110 may determine the reference duration as a duration of PSSCH in a slot. The slot contains no PSFCH and is a last slot before a timing when the first terminal device 110 starts the channel access procedure. For the case that sidelink A/N is used for CW determining, the corresponding PSSCH resource in a slot used for sidelink information transmission may be different. That is, when other sidelink channel is also contained in the same slot, such as PSFCH, the actual resource used as PSSCH would be less than the ones with no PSFCH. The reference duration determined as a duration of PSSCH without PSFCH in a same slot which holding more resource for data transmission may present the channel status and data transmission result more precisely and make CW adjustment more reasonable. This will be described with reference to FIG. 8D.

In the example as shown in FIG. 8D, within a sidelink CO, a starting slot 821 (i.e., the first slot in order) contains both PSSCH and PSFCH resources, while a slot 822 immediately following the starting slot 821 (i.e., the second slot in order) contains only PSSCH and no PSFCH. According to the rule of determining a reference duration, a duration of PSSCH in the second slot 822 within the CO is determined as the reference duration. In other words, the duration of PSSCH in a starting slot (i.e., the first slot in order) in a sidelink CO which contains no PSFCH is determined as the reference duration.

In the example as shown in FIG. 8E, the first terminal device 110 may determine CW by detecting all potential sidelink A/N on PSFCH in a reference duration, and the PSFCH resource allocation should be determined based on sidelink channel structure and configuration. As shown, as a system pre-definition, the reference duration is determined as a duration containing last M=3 slots which contain candidate PSFCH resources. That is, the reference duration is determined as a duration containing slots #1, #3 and #5 which contain candidate PSFCH resources.

In some embodiments, the first terminal device 110 may determine a beginning of a sidelink CO as a beginning of the reference duration and an end of a PSCCH containing SCI as an end of the reference duration. The PSCCH is contained in the sidelink CO, and the SCI indicates information about the sidelink CO. In such embodiments, the reference duration is determined according to the sidelink channel scheme or configuration. Therefore, it is a general definition of reference duration which may be used by all sidelink terminal devices and has no concern with actual sidelink transmission or sidelink channel access. In this way, other terminal devices receiving the SCI may determine CW precisely and timely. This will be described with reference to FIG. 8F.

In the example as shown in FIG. 8F, a sidelink CO is initiated by a sidelink terminal device, SCI may be indicated by the sidelink terminal device on PSCCH resource within the CO to assign the information relevant to the CO, e.g., the length, priority, usage, resource allocation of the CO, and the like. Upon receiving the SCI, the first terminal device 110 may determine a beginning of the sidelink CO as a beginning of the reference duration, and an end of the PSCCH containing the SCI as an end of the reference duration.

In some embodiments, the first terminal device 110 may determine the reference duration as a last sidelink CO which ends no later than a timing when the first terminal device 110 receives a sidelink grant. The duration of the last sidelink CO exceeds a threshold. As sidelink CR and CBR are dedicated parameters which present the channel status of sidelink and used for sidelink resource selection, a CW determined based on sidelink CR or CBR is a common solution for sidelink terminal devices and introduces less overhead. Accordingly, sidelink CR or CBR needs certain duration of sidelink CO to obtain available evaluation, and a corresponding reference duration should be determined to satisfy the requirement of sidelink CR/CBR evaluation. This will be described with reference to FIG. 8G.

In the example as shown in FIG. 8G, when the first terminal device 110 receives a sidelink grant, a CW may be determined. The first terminal device 110 may listen to the channel and evaluate sidelink CR/CBR in a reference duration and further determine the CW according to the CR/CBR. In order to obtain reasonable evaluation of CR/CBR, the reference duration is determined as a duration of a last sidelink CO with a length larger than or equals to K=5 ms.

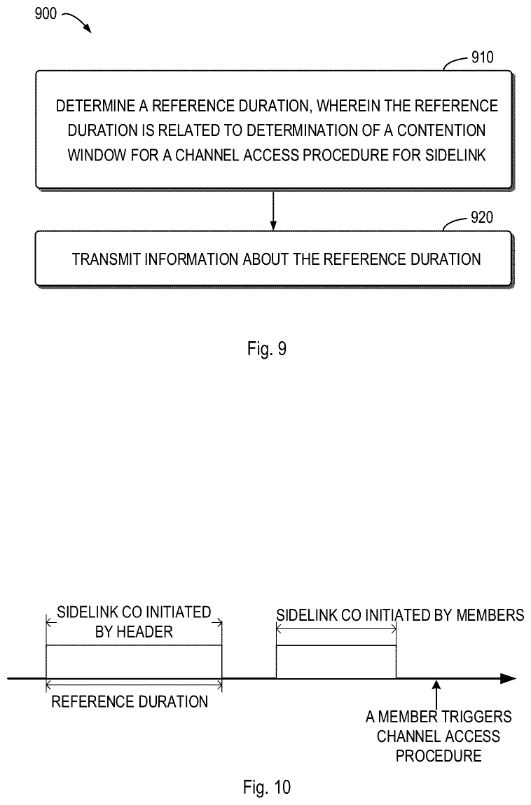

For some scenarios, such as sidelink unicast, groupcast, or network device scheduling a sidelink terminal device in unlicensed band, the sidelink CW should be determined based on a reference duration which is related to a control node device of the sidelink communication. This will be described with reference to FIG. 9.

FIG. 9 illustrates a flowchart of an example method 900 in accordance with some embodiments of the present disclosure. In some embodiments, the method 900 can be implemented at a control node device. In some embodiments, the control node device may comprise one of the following: a network device (such as one of the network devices 140 and 150 as shown in FIG. 1), a road side unit, a header terminal device in a sidelink communication group, or a terminal device (such as one of the second terminal device 120 and the third terminal device 130) paired for sidelink unicast communication.

At block 910, the control node device determines a reference duration. The reference duration is related to determination of a CW for a channel access procedure for sidelink. At block 920, the control node device transmits information about the reference duration.

The method 900 may benefit sidelink resource coordination and management.

In some embodiments, the information about the reference duration may comprise at least one of the following: a beginning of the reference duration, an end of the reference duration, or a length of the reference duration.

In embodiments where the first terminal device 110 receives the information about the reference duration, the first terminal device 110 may determine a reference duration for the first terminal device 110 based on the received information.

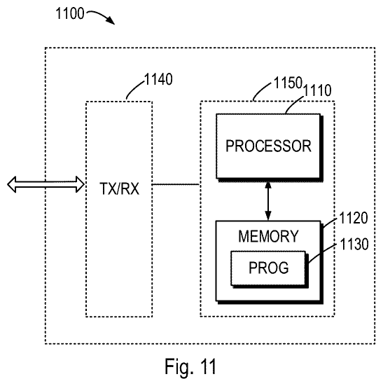

In embodiments where the first terminal device 110 receives the information about the reference duration, the first terminal device 110 may determine the reference duration as one of the following: a last CO initiated by the control node device, or a duration within a CO initiated by the control node device. This will be described with reference to FIG. 10.

FIG. 10 illustrates an example of a reference duration in accordance with some embodiments of the present disclosure. In the example as shown in FIG. 10, a sidelink communication group comprises several sidelink terminal devices. A header terminal device (also referred to as header in FIG. 10) in the group initiates a sidelink CO and transmits information to member terminal devices. A member terminal device (also referred to as member in FIG. 10) detects and receives signal within sidelink COs from header terminal device and other member terminal devices, the member terminal device determines the reference duration as a duration within a last CO initiated by the header terminal device.

In some embodiments, two terminal devices performing sidelink unicast may be the pair terminal device for each other, and a reference duration may be indicated by the pair terminal device in a sidelink unicast. It provides more flexibility on reference duration determining and may be used for some specific scenarios, e.g., sidelink unicast, groupcast with a control node in the group, and so on.

For example, the first terminal device 110 and the second terminal device 120 perform sidelink unicast and maintain PC5 RRC connection with each other. In this case, the first terminal device 110 may be named as the pair terminal device to the second terminal device 120, and vice versa.

Between the pair of terminal devices, the first terminal device 110 may share a sidelink initiated by itself with the second terminal device 120, and indicates a reference duration with fixed 5 ms which starts from a beginning of the CO. Based on the indication, the second terminal device 120 may further determine its CW based on the assigned reference duration.

FIG. 11 is a simplified block diagram of a device 1100 that is suitable for implementing some embodiments of the present disclosure. The device 1100 can be considered as a further example embodiment of one of the terminal devices 110, 120 and 130 or one of the network devices 140 and 150 as shown in FIG. 1. Accordingly, the device 1100 can be implemented at or as at least a part of one of the terminal devices 110, 120 and 130 or one of the network devices 140 and 150.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-42. (canceled)

43. A method performed by a terminal device, the method comprising:
determining a contention window value for a channel access procedure for sidelink based on a Hybrid Automatic Repeat Request (HARQ) feedback corresponding to a Physical Sidelink Shared Channel (PSSCH) in a reference duration, in accordance with a determination of whether the PSSCH is for a unicast sidelink transmission or a groupcast sidelink transmission, wherein the reference duration is a duration where at least one PSSCH with the HARQ feedback comprising ACK or NACK is transmitted; and
transmitting a sidelink transmission using the channel access procedure.

44. The method of claim 43, wherein the reference duration starts from beginning of channel occupancy initiated by the terminal device including a sidelink transmission until end of a starting slot where the at least one PSSCH is transmitted.

45. The method of claim 43, wherein the PSSCH is for the unicast sidelink transmission or the groupcast sidelink transmission is indicated by a sidelink control information (SCI).

46. A terminal device, comprising a processor configured to:
determine a contention window value for a channel access procedure for sidelink based on a Hybrid Automatic Repeat Request (HARQ) feedback corresponding to a Physical Sidelink Shared Channel (PSSCH) in a reference duration, in accordance with a determination of whether the PSSCH is for a unicast sidelink transmission or a groupcast sidelink transmission, wherein the reference duration is a duration where at least one PSSCH with the HARQ feedback comprising ACK or NACK is transmitted; and
transmit a sidelink transmission using the channel access procedure.

47. The terminal device of claim 46, wherein the reference duration starts from beginning of channel occupancy initiated by the terminal device including a sidelink transmission until end of a starting slot where the at least one PSSCH is transmitted.

48. The terminal device of claim 46, wherein the PSSCH is for the unicast sidelink transmission or the groupcast sidelink transmission is indicated by a sidelink control information (SCI).
